(19) United States
(12) Patent Application Publication
(10) Pub. No.: US 2014/0087067 A1
(43) Pub. Date: Mar. 27, 2014

(54) METHOD OF COATING A METAL MOLD SURFACE WITH A POLYMER COATING, MOLD FOR RUBBER PRODUCTS AND METHOD OF MOLDING RUBBER PRODUCTS

(71) Applicants: Frederic Gerard Auguste Siffer, Akron, OH (US); Jimmy Lee Richards, Rootstown, OH (US)

(72) Inventors: Frederic Gerard Auguste Siffer, Akron, OH (US); Jimmy Lee Richards, Rootstown, OH (US)

(21) Appl. No.: 13/623,922

(22) Filed: Sep. 21, 2012

(51) Int. Cl. B29C 33/58

(52) U.S. Cl. 427/135

(57) ABSTRACT

This invention relates to preparation of a metal mold surface for molding rubber products by plasma jet directed polymer coating, a coated mold for rubber products and production of rubber products. Such rubber products are rubber tires and industrial products, particularly rubber tires.

### FIELD OF THE INVENTION

This invention relates to preparation of a metal mold surface for molding rubber products by plasma jet directed polymer coating, a coated mold for rubber products and production of rubber products. Such rubber products are rubber tires and industrial products, particularly rubber tires.

### BACKGROUND

Rubber products, such as for example pneumatic rubber tires, are typically produced by molding and curing sulfur curable green, or uncured, rubber tires in a tire mold in which the uncured pneumatic rubber tire is pressed outwardly against a metal mold surface by means of an internal fluid expanding rubber bladder (e.g. by application of internal steam pressure to the bladder envelop). By such method the uncured rubber tire is pressed against and shaped against the metal mold surface which defines the tire's tread pattern and configuration of its sidewalls and during which a portion of the rubber in proximity to the mold surface flows to permit the rubber to assume the contours of the mold surface. By application of heat to the mold, the tire is cured within the mold. The mold is then opened and the cured tire removed from the mold. Such pneumatic rubber tire molding and curing is well known to those having skill in such art.

It is important that such molded and sulfur cured rubber products such as tires be readily removable from their tire molds. A release coating is sometimes applied to the surface of the uncured tire to allow the cured tire to be suitably removed from the mold. It is both economically and physically desirable to provide a durable release coating on a tire mold surface itself to provide a releasability of the molded tire from the tire mold over repeated tire molding and curing cycles.

Further, by repeated tire molding and curing cycles, the mold surface of a metal tire mold may be subject to a buildup of materials, or debris, on its surface. Buildup of materials on the mold surface may sometimes be referred to mold fouling which may, for example, affect cosmetic appearance of the surface of the molded tire. Such fouled metal tire mold surface may be periodically cleaned to remove such mold fouling when appropriate. Such tendency for mold fouling is well known to those having skill in such art.

Therefore, in practice, it may be desired to promote releasability of sulfur cured rubber products such as tires, as well as various industrial product such as, for example belts, hoses, track pads and shoes, from their mold surfaces and, further, to retard, diminish or substantially prevent or release mold fouling of the surface of the rubber (e.g. tire) mold.

For this invention, it desired to evaluate a plasma induced polymer coating of a metal mold surface for molding rubber products (e.g. tires) to promote releasability of a cured rubber product.

### SUMMARY AND PRACTICE OF THE INVENTION

The present invention is directed to a method of treating a metal (e.g. steel or aluminum) mold surface for molding and curing rubber products (e.g. tires) which comprises applying a thin polymer layer to the surface of the mold to facilitate removal of a rubber product having been cured with in such mold.

A plurality of such coatings on the metal mold surface is contemplated.

Further, a mold for rubber products (e.g. tires) is provided with a coated metal surface (e.g. steel or aluminum surface) prepared by said method.

In addition, a method of molding and curing a rubber product (e.g. pneumatic rubber tire) is provided.

In accordance with this invention, a method of treating a metal surface of a mold for molding and curing rubber products is provided which comprises directing an atmospheric plasma jet comprised of an ionized gas containing a polymerizable precursor (e.g. atomized liquid polymerizable precursor) to a metal molding surface of the mold to form and bond a thin polymer layer of plasma polymerized precursor on said metal mold surface to promote release of a cured rubber product from said treated mold surface.

In one embodiment, said ionized gas for said plasma is electrically ionized by, for example, allowing said gas to pass between a set of positive and negative electrodes (e.g. an electric arc) to cause the gas to be in a high state of high energy environment to thereby promote polymerization of the introduced polymerizable precursor.

Such deposited polymer on said metal mold surface from said plasma is in a form of a polymer layer having a thickness, for example, in a range of from about 10 nm to about 500 nm and is provided from polymerizable precursors so long the resulting polymer has an ability to promote releasability of a cured rubber product from the deposited polymer layer on the metal mold surface.

Representative of such rubber products are pneumatic rubber tires and engineered (e.g. industrial) rubber products comprised, of for example, belts (e.g. power and transmission belts), hoses, vehicular track pads and shoes.

It is to be appreciated that the atmospheric plasma jets may be in a form of pulse or continuous plasmas. The plasmas may be generated, for example, from dielectric barrier jets, microwave torches, radio-frequency torches, low frequency torches, current-carrying arc plasma jets, or by any other means of producing a suitable atmospheric plasma able to polymerize organic precursors of polymers known to one skilled in such art.

While there are additional methods of creating an atmospheric plasma jet, a current-carrying arc plasma jet, appears to be an acceptable means of applying the thin polymer layer to the metal mold surface.

In practice, to the ionized gas may be introduced a small particle sized (e.g. atomized) liquid polymerizable precursor (polymer precursor, namely a precursor to form a polymer) to form a plasma jet, expelled through and from a torch, comprised of the ionized gas and atomized precursor for which polymerization of the precursor is promoted by the high energy environment provided by the plasma.

The plasma jet is directed (e.g. directed from its torch) to a molding surface of the steel or aluminum mold to form and deposit a thin polymer layer (e.g. coating) from the polymerized precursor on said steel surface of the mold by polymerization of said polymerizable precursor.

In one embodiment, it is desired that the polymer layer is bonded to the steel or aluminum mold surface in a sense of chemical bonding of the polymerized coating to the surface of the steel or aluminum is created as a result of the high plasma energy environment.

In one embodiment, it is desired that the polymer layer resists significant adhesion of the rubber to thereby permit the molded and cured rubber to be releasable from the mold surface, (e.g. to permit removal of the molded rubber product from the mold surface).

In one embodiment, it is desired that the polymer is comprised of a crosslinked polymer in a sense of it has been observed that the plasma polymerized coatings usually exhibit some degree of crosslinking. In this manner, it is believed that a degree of crosslink density within the polymer coating promotes mechanical strength to withstand abrasion when taking cured tires out of the mold.

By atmospheric pressure plasma, it is meant that the pressure of the plasma is equal to or slightly above the ambient pressure of the surroundings. The pressure of the plasma may be desirably somewhat higher than ambient, such that the plasma pressure is sufficient to induce the desired flow rate through a plasma generator which contains an ionized gas promoting electric arc.

An ionizable gas (e.g. carrier gas for the polymerizable polymer precursor) may be, for example a noble gas such as, for example helium, argon, xenon and neon as well as, for example, oxygen, nitrogen, carbon dioxide, nitrous oxide and air. In one embodiment, such ionizable gas is argon.

A carrier gas to carry the atomized liquid polymerizable precursor to the plasma plume may be for example also a noble gas such as, for example, helium, argon, xenon and neon as well as, for example, oxygen, nitrogen, carbon dioxide, nitrous oxide and air. In one embodiment such carrier gas is argon.

Representative of such polymerizable precursors may be comprised of, for example, and not intended to be limiting, one or more of disiloxanes, disilazanes, perfluoroacrylates (e.g. perfluorooctylacrylate and perfluorooctylmethacrylate), fluorinated silanes, vinylidene fluoride.

For example, such polymerizable precursors may be a disiloxane such as, for example, hexamethyldisiloxane; a disilazane such as for example hexamethyldisilazane; fluorinated silane comprised of, for example, 1H, 1H, 2H-perfluorooctyltriethoxysilane and other fluorinated compounds comprised of at least one of 1H, 1H, 2H-perfluoro-1-alkylene where said alkylene group is comprised of decene, octene, hexene or butene groups or 1H, 1H, 2H-perfluoro-1-alkanol where said alkanol group is comprised of decanol, octanol, hexanol or butanol groups and fluorinated compounds such as, for example perfluoromethylcyclohexane, perfluorodimethylcyclohexane, hexafluorobenzene, perfluoromethyl vinyl ether, perfluoroethyl vinyl ether, perfluoropropyl vinyl ether, perfluorodimethylcyclobutane, perfluoromethylcyclopentane, perfluoromethyldecalin, tetrafluoroethylene, hexafluoropropylene and perfluorobutyl ethylene.

Such disiloxane, disilazane, fluorinated silane, vinylidene fluoride and fluorinated compounds may be combined, if desired and appropriate with said perfluoroacrylates to form a precursor for said plasma coating method and to thereby form a copolymer thereof.

The practice of the method of this invention is considered as being significant in a sense of being able to refresh the coating on the metal mold surface at a rubber product (e.g. pneumatic tire) manufacturing facility, particularly where a thin coating is desired to be applied by an energy and polymer precursor efficient method.

For a batch process wherein an object is exposed to an atmospheric plasma, the object may be exposed, for example, to the plasma for a period of from about 1 to about 100 seconds. In a continuous process, the exposure time may be characterized by a residence time expressed as the length or circumference of the object to be treated (e.g. in centimeters) with the plasma torch divided by the torch velocity (e.g. in cm/sec) multiplied by the number of plasma treatments applied to the object. The residence time in such a continuous process would then range, for example, from about 0.5 to about 100 seconds.

The flow rate of atomized precursor into the plasma generator necessary to obtain an effective amount of polymerized or partially polymerized precursor onto the mold surface will depend on the desired face velocity in the plasma generator, i.e. the gas velocity (e.g. in cm/sec) exiting the plasma torch. Necessary flow rate may be determined by one skilled in the art without undue experimentation.

The following drawings are provided for further understanding of the invention and are not intended to be limiting.

### The Drawings

A method is depicted for providing a thin polymer layer for enhancing releasability of sulfur cured rubber from a steel or aluminum surface, such as for example a metal surface of a mold for rubber products, such as for example tires and industrial products such as for example, belts, hoses, tracks and shoes, particularly a tire mold.

### IN THE DRAWINGS

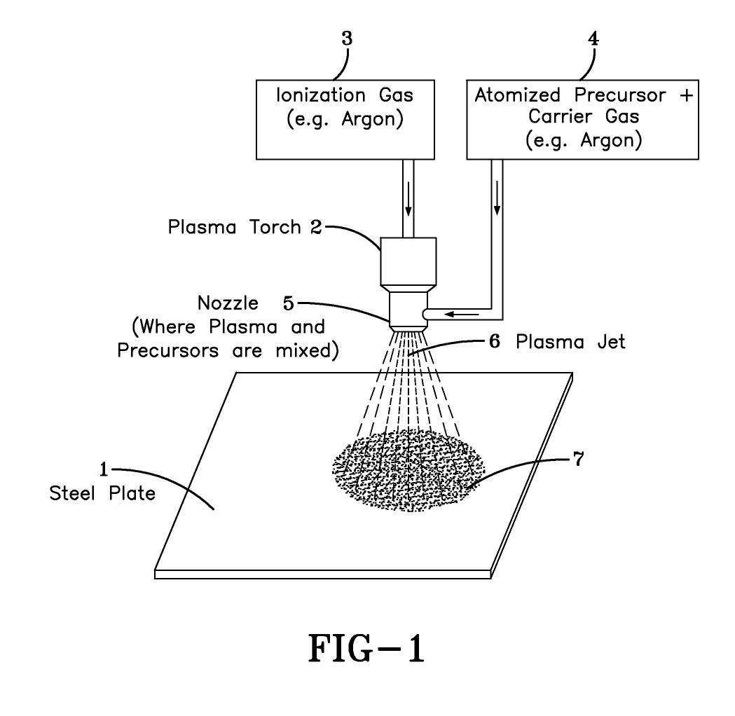

In FIG. 1 (FIG. 1) a steel plate (1), is sandblasted.

To a cylindrical torch (2) device is fed a stream (3) of argon gas in which the argon gas is caused to pass through between positive and negative electrodes to ionize the argon gas to a high energy level at a flow rate through the torch (2) device of about 800 liters/hour (1/hr).

To the torch (2) device is introduced a stream of atomized precursor (4) carried by a carrier gas (5), namely argon gas where the atomized precursor (4 ) stream, namely a polymer precursor, is introduced into the stream (3) of argon gas, at substantially ambient atmospheric pressure, in the nozzle (6) of the torch (2) device to create a plasma jet (7) comprised of the stream (3) of ionized gas which contains the atomized precursor (4).

The plasma jet (7) is passed over the steel plate (1) to deposit a thin polymer coating (8) onto the steel plate (1) created by the atomized precursor (4) contained in the stream (3) of ionized argon gas.

The invention is further described with reference to the following examples.

### EXAMPLE

In this example, treatments of sandblasted steel plates by an atmospheric plasma jet by which a polymerizable precursor is introduced are evaluated for providing a coating of polymer on the steel surface and compared to a steel plate without such treatment.

The plasma is provided as an electrical arc-formed ionized argon gas to which an atomized liquid polymerizable precursor is introduced. A polymerization of the precursor is promoted by the highly ionized argon gas in a sense being in a nature of what is believed to be a free radical polymerization process.

The liquid polymerizable precursor used was comprised of 70 weight percent hexamethyldisiloxane (HMDSO) and 30 weight percent 1H,1H,2H,2H-perfluorooctyl acrylate (PFOA).

For this evaluation, 1 cm by 3 cm steel plates were positioned on a table and held stationary while the plasma jet was applied by the plasma torch device where the plasma jet was comprised of the high energy ionized argon gas containing the atomized liquid polymerizable precursor for which one or more passes of the torch device, and thereby the jet, over the surface of the steel plates.

An electrical arc power of 70 watts was provided through which the argon gas was passed within the torch device to cause its ionization.

The argon gas flow rate through the torch was about 800 liters/hour to which an atomized liquid polymerizable precursor is injected to form the plasma torch.

The plasma torch comprised of the ionized argon gas and polymerizable precursor is directed to and thereby applied to the surface of the steel plate in one and three passes. The period of exposure for each pass was about 15 seconds.

Three samples of the steel plate were evaluated and identified herein as Samples A, B and C.

The surface of all of the steel Samples had been pre-sandblasted with a fine grain sand.

Control Sample A was a steel plate without exposure by the plasma torch.

Experimental Sample B was a steel plate to which one pass of the plasma torch was applied to deposit the precursor in a form of a polymer layer on the steel plate.

Experimental Sample C was a steel plate to which three individual passes of the plasma torch was applied to deposit the precursor in a form of a polymer layer on the steel plate in a more homogeneous form therefore reducing the occurrence of pin holes.

To the steel plate Control Sample A and Experimental polymer coated Samples B and C were applied sulfur curable rubber blocks and the rubber blocks cured under conditions of elevated temperature and pressure against the Control and Experimental steel plates (for example at a temperature of about 155° C. for about 35 minutes).

After cooling to room temperature (about 23° C.), the energy needed to pull the cured rubber blocks from each of the steel plate Control Sample A and polymer coated Experimental steel plates B and C was measured and reported in the following Table 1.

TABLE 1

| | | Average |
|---|---|---|
| Sample | Coating Passes | Separation Energy, millijoules (mJ) |
| A (Control) | 0 | 1494 |
| B (Experimental) | 1 | 438 |
| C (Experimental) | 3 | 112 |

From Table 1 it can be seen that the energy needed to pull the cured rubber off of the steel plate drastically decreases when a plasma coating is applied as compared to the reference, or control, steel plate. Higher number of passes leads to a more homogeneous coating and therefore better release performances.

This is considered as being significant in a sense of that a thin plasma coated polymerized layer plays the role of a release coating.

Therefore, it is concluded that the level of performance of aforementioned plasma polymers as a release coating is similar to the one obtained with other more traditional release coatings. In addition, the plasma coating process can be done on-site using minimal amounts of energy, chemicals and handling while providing flexibility, on-demand mold coating as well as the possibility to automate the plasma coating process.

While various embodiments are disclosed herein for practicing the invention, it will be apparent to those skilled in this art that various changes and modifications may be made therein without departing from the spirit or scope of the invention.

What is claimed is:

1. A method of treating a metal surface of a mold for molding and curing rubber products which comprises applying an atmospheric plasma comprised of an ionized gas containing a polymerizable precursor to a metal molding surface of the mold metal surface to form and bond a thin polymer layer of plasma polymerized precursor on said mold metal surface to promote release of a cured rubber product from said treated mold surface.

2. The method of claim 1 wherein said metal mold surface is comprised of steel or aluminum.

3. The method of claim 1 wherein said mold is a mold for molding and curing pneumatic rubber tires.

4. The method of claim 1 wherein said mold is a mold for molding and curing rubber products comprised of belts, hoses, vehicular track pads or shoes.

5. The method of claim 1, wherein the ionized plasma gas is comprised of at least one of argon, helium, neon, xenon, oxygen, nitrogen, nitrous oxide and carbon dioxide.

6. The method of claim 5 wherein said ionized plasma gas is comprised of argon.

7. The method of claim 1 where said polymerizable precursor is an atomized liquid polymerizable precursor contained in a carrier gas for the precursor and introduced into said ionized gas.

8. The method of claim 7, wherein said carrier gas for said polymerizable precursor is comprised of at least one of argon, helium, neon, xenon, oxygen, nitrogen, nitrous oxide and carbon dioxide.

9. The method of claim 8 wherein said carrier gas is comprised of argon.

10. The method of claim 1, wherein said precursor is a polymerizable monomer comprised of at least one of disiloxanes, disilazanes, perfluoroacrylates, fluorinated silanes, vinylidene fluoride.

11. The method of claim 1 wherein said precursor is a polymerizable monomer comprised of at least one of alkyldisiloxane comprised of hexamethyldisiloxane; disilazane comprised of hexamethyldisilazane; fluorinated silane comprised of 1H, 1H, 2H-perfluorooctyltriethoxysilane, 1H, 1H, 2H-perfluoro-1-alkylene where said alkylene group is comprised of decene, octene, hexene or butene groups or 1H, 1H, 2H-perfluoro-1-alkanol where said alkanol group is comprised of decanol, octanol, hexanol or butanol groups;
vinylidene fluoride and fluorinated compounds comprised of at least one of perfluoromethylcyclohexane, perfluorodimethylcyclohexane, hexafluorobenzene, perfluoromethyl vinyl ether, perfluoroethyl vinyl ether, perfluoropropyl vinyl ether, perfluorodimethylcyclobutane, perfluoromethylcyclopentane, perfluoromethyldecalin, tetrafluoroethylene, hexafluoropropylene and perfluorobutyl ethylene.

12. The method of claim 1 wherein said precursor is a perfluoroacrylate comprised of at least one of perfluorooctylacrylate and perfluorooctylmethacrylate.

13. The method of claim 11 wherein precursor is combined with a perfluoroacrylate.

14. The method of claim 13 wherein said perfluoroacrylate is comprised of at least one of perfluorooctylacrylate and perfluorooctylmethacrylate.

15. The method of claim 10 wherein said precursor is a disiloxane comprised of hexamethyldisilazane.

16. The method of claim 10 wherein said precursor is a fluorinated compound comprised of at least one of said 1H, 1H, 2H-perfluorooctyltriethoxysilane, 1H, 1H, 2H-perfluoro-1-alkylene, 1H, 1H, 2H-perfluoro-1-alkanol, perfluoromethylcyclohexane, perfluorodimethylcyclohexane, hexafluorobenzene, perfluoromethyl vinyl ether, perfluoroethyl vinyl ether, perfluoropropyl vinyl ether, perfluorodimethylcyclobutane, perfluoromethylcyclopentane, perfluoromethyldecalin, tetrafluoroethylene, hexafluoropropylene and perfluorobutyl ethylene.

17. A mold for molding and curing rubber products prepared by method claim 1.

18. The mold of claim 16 as mold for molding and curing pneumatic rubber tires.

19. A method of preparing a rubber product comprised of molding and curing a rubber product in the mold of claim 17.

20. A method of preparing a pneumatic rubber tire comprised of molding and curing a pneumatic rubber tire in the mold of claim 18.
